(19) United States
(12) Patent Application Publication
(10) Pub. No.: US 2002/0144004 A1
(43) Pub. Date: Oct. 3, 2002

(54) Driver having multiple deferred procedure calls for interrupt processing and method for interrupt processing

(76) Inventors: Daniel R. Gaur, Beaverton, OR (US); Patrick L. Connor, Portland, OR (US); Lucas M. Jenison, Hillsboro, OR (US); Patrick J. Luhmann, Hillsboro, OR (US); Linden Minnick, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/823,155

(22) Filed: Mar. 29, 2001

(51) Int. Cl. G06F 9/46; G06F 15/163; G06F 9/54; G06F 9/00

(52) U.S. Cl. 709/310

(57) ABSTRACT

A driver having an interrupt service routine including an interrupt handler and at least two deferred procedure calls. Each of the at least two deferred procedure calls is associated with a particular interrupt event or type of interrupt event. If multiple interrupt events occur, the interrupt events may be concurrently processed on separate deferred procedure calls, resulting in a substantially reduced interrupt handling latency.

### FIELD OF THE INVENTION

The invention relates generally to drivers for computer systems and other electronic systems. Specifically, the invention relates to a driver having an interrupt service routine implementing multiple deferred procedure calls for interrupt processing.

### BACKGROUND OF THE INVENTION

A computer system typically includes one or more peripheral devices, such as, for example, a printer, disk drive, keyboard, video monitor, and/or a network interface card (NIC). Programs running on such a computer system generally utilize device drivers to access and interface with peripheral devices, as well as other systems and components. A device driver is a program or piece of code that controls a peripheral device, and the peripheral device will typically have its own set of specialized commands that only its driver is configured to recognize. Most programs, however, access a peripheral device using a generic set of commands, and the device's driver accepts these generic commands from a program and translates the generic commands into specialized commands for the device. Thus, a device driver essentially functions as a translator between a device and programs that use or access that device. Tasks performed by a driver include, by way of example, executing data input and output (I/O) operations, carrying out any error processing required by a device, and interrupt processing.

In addition to drivers associated with peripheral devices, other types of drivers are known in the art, including intermediate drivers, file system drivers, network drivers, and multimedia drivers, as well as other drivers. An intermediate driver is one layered on top of a device driver (e.g., a “class” driver), and any number of such drivers may be layered between an application program and the device driver. File system drivers are generally responsible for maintaining the on-disk structures needed by various file systems. In addition to NIC drivers, network drivers include, by way of example, transport drivers for implementing a specific network protocol, such as TCP/IP. See Transmission Control Protocol, Internet Engineering Task Force Request For Comments (IETF RFC) 793, and Internet Protocol, IETF RFC 791. Multimedia drivers include those for waveform audio hardware, CD players, joysticks, and MIDI ports. See Musical Instrument Digital Interface 1.0, v96.1.

As noted above, interrupt processing is a function typically performed by a driver. Most peripheral devices coupled to a computer system generate an electrical signal, or interrupt, when they need some form of attention from a CPU or processor. This interrupt is an asynchronous event that suspends normal processing of the CPU. For example, a peripheral device may generate an interrupt signaling it has completed a previously requested I/O operation and is now idle or signaling that it has encountered some kind of error during an I/O operation. When a CPU receives an interrupt, the CPU will suspend all or a portion of the instructions or code currently executing, save any information necessary to resume execution of the interrupted code (i.e., a context save), determine the priority of the interrupt, and transfer control to an interrupt service routine associated with the interrupt. The interrupt service routine, which forms a part of the driver associated with the interrupted device, then processes the interrupt. Generally, when a CPU accepts an interrupt, the CPU blocks out any other interrupts of equal or lesser priority until that interrupt has been processed.

It should be understood that one may distinguish between the interrupt signal asserted by a device and the circumstance—i.e., the “interrupt event”—causing the device to assert the interrupt signal. A device may having only one signal line (or status bit) for asserting an interrupt signal or, as is often the case, a device must assert its interrupt signal on only one signal line in order to comply with a specification. However, any one of a number of interrupt events may cause the device to assert an interrupt signal on this signal line, and additional interrupt events may occur on a device after the device has asserted its interrupt signal.

An interrupt service routine may include two distinct pieces of code for processing interrupts: an interrupt handler and a deferred procedure call. The interrupt handler is a high priority piece of code that acknowledges an interrupt and determines which interrupt event, or events, caused the interrupt signal to be asserted. A deferred procedure call (DPC) is a lower priority piece of code that actually processes the interrupt event(s) that caused the device to generate an interrupt and takes any actions necessary to remedy the situation (e.g., return to an idle state). Because the priority of the deferred procedure call is lower than that of the interrupt handler, execution of the deferred procedure call is delayed relative to the interrupt handler and the amount of time the CPU must spend servicing time-critical events is minimized. The interrupt handler also prevents the device from generating additional interrupt signals until the interrupt is reenabled at some point during or after execution of the deferred procedure call.

As suggested above, a driver is usually configured to process multiple types of interrupt events, and a driver's interrupt service routine includes a single deferred procedure call for processing these interrupt events. During operation, if an interrupt is generated and is acknowledged by the interrupt handler, the interrupt handler requests the deferred procedure call and assigns the deferred procedure call to a resource. The time required to request the deferred procedure call and assign the deferred procedure call to a resource is commonly referred to as the DPC scheduling latency.

The resource to which the deferred procedure call is assigned typically comprises a conventional processor capable of executing a single thread at a time, and the deferred procedure call is executed on this single thread. A thread is a unique stream of control—embodied in a set of registers, such as a program counter, a stack pointer, and general registers—that can execute its instructions independent of other threads, and the code executing on a thread is not part of that thread (i.e., the code is global and can be executed on any thread). The resource may also comprise a processor having multiple threads of execution or one processor of a multi-processor system; however, conventional drivers do not adequately utilize such resources, as all interrupt events (of a particular device) are processed by only one deferred procedure call executing on a single thread.

If additional interrupt events occur after the time at which an interrupt is asserted due to a first interrupt event, the deferred procedure call will process each of the interrupt events one by one on the single thread of execution. Accordingly, an artificial serialization is imposed on interrupt processing, and this serialization results in a significant latency (i.e., the time necessary to handle a series of interrupt events) associated with interrupt processing. Although multi-threaded processors, as well as multi-processor systems, are known in the art, conventional drivers do not utilize the computing resources provided by such devices and/or systems, as noted above.

### BRIEF DESCRIPTION OF THE DRAWINGS

FIG. 1 shows a schematic diagram of an exemplary embodiment of a conventional computer system.

FIG. 2 shows a schematic diagram of a conventional interrupt processing routine.

FIG. 3 shows a schematic diagram of one embodiment of a method of interrupt processing according to the present invention.

### DETAILED DESCRIPTION OF THE INVENTION

The above-noted serialization and corresponding latency inherent in conventional interrupt handling schemes is significantly reduced using an interrupt service routine configured to concurrently execute multiple deferred procedure calls and, hence, multiple interrupt events. Any type of driver may implement such an interrupt service routine. As used herein, the term “driver” refers to any type of driver known in the art, including device drivers, intermediate drivers, file system drivers, network drivers, and multimedia drivers, as well as other drivers.

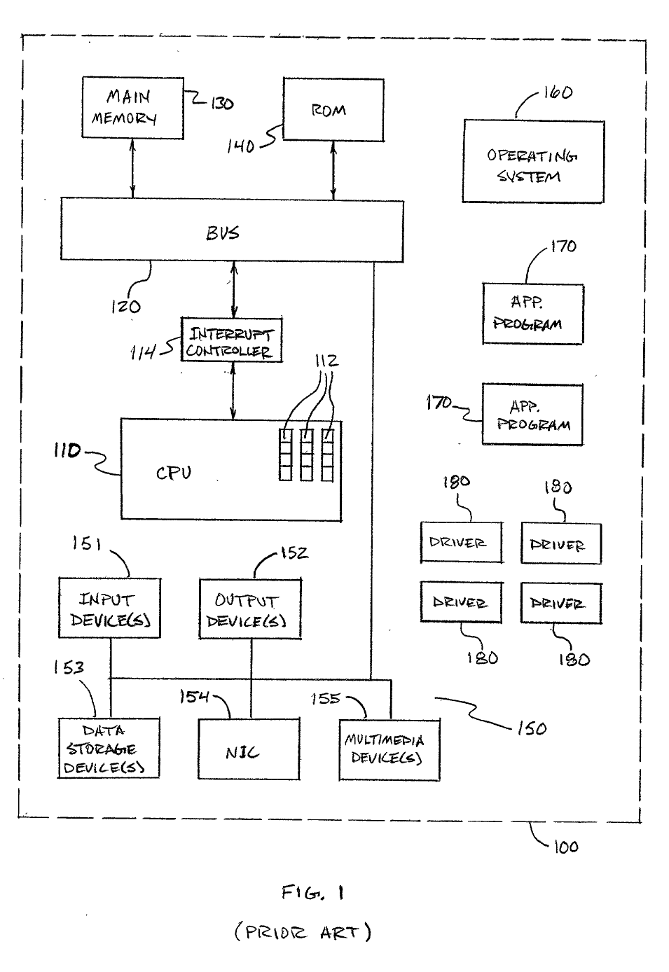

Referring to FIG. 1, an exemplary embodiment of a conventional computer system 100 includes a CPU 110, which may comprise any processor known in the art. The CPU 110 includes one or more execution threads 112. Alternatively, the computer system 100 may include a plurality of CPUs or processors 110 (i.e., a multi-processor system). The CPU 110 is coupled via a bus 120 to main memory 130, which may comprise one or more dynamic random access memory (DRAM) devices for storing information and instructions to be executed by CPU 110. The main memory 130 may also be used for storing temporary variables or other intermediate information during execution of instructions by CPU 110. Computer system 100 also includes read only memory (ROM) 140 coupled via bus 120 to CPU 110 for storing static information and instructions for CPU 110.

The computer system 100 may also include an interrupt controller 114 coupled to CPU 110. The interrupt controller 114 may perform any one or more of a number of functions, including acknowledging an interrupt from a peripheral device, determining a priority of the interrupt received, providing a request for interrupt processing to the CPU 110, and halting servicing of the interrupted device if a higher priority interrupt is received. The interrupt controller 114—or the functions performed by such an interrupt controller—may be integrated into the CPU 110, or the interrupt controller 114 may comprise a separate component (and, in practice, the interrupt controller 114 is commonly integrated into a chipset accompanying a processor). For ease of understanding, it is assumed herein that the interrupt controller 114 and/or the functions it performs are integrated into the CPU 110. However, the present invention is generally applicable to all types of computer systems, irrespective of the particular architecture employed, and it should be understood that a computer system may include a separate interrupt controller 114, as noted above.

The computer system 100 also includes one or more peripheral devices 150 coupled to CPU 110 via bus 120. A peripheral device may comprise, for example, an input device 151, an output device 152, a data storage device 153, a network interface controller 154, or a multimedia device 155. An input device 151 typically comprises a keyboard or a mouse, and common output devices 152 include printers and display monitors. A data storage device 153 may comprise a hard disk drive, floppy disk drive, or a CD ROM drive. Network interface controller 154 may comprise any such device known in the art. Exemplary multimedia devices 155 include waveform audio hardware, CD players, joysticks, and MIDI ports.

Resident on computer system 100 is an operating system 160, which may comprise any operating system known in the art including Unix®, Windows® 98, Windows® NT, Macintosh® O/S, or Novell® NetWare. Operating system 160 handles the interface to peripheral devices 150, schedules tasks, and presents a default interface to a user when no application program is running, as well as performing other functions. The computer system 100 may also have one or more application programs 170 resident thereon and running. Typical application programs include, by way of example, word processors, database managers, graphics or CAD programs, and email. Computer system 100 further includes one or more drivers 180. Each driver 180 comprises a program or piece of code providing an interface between a peripheral device 150 and the operating system 160 and/or an application program 170.

It will be understood by those of ordinary skill in the art that the computer system 100 may include other components and subsystems in addition to those shown and described with respect to FIG. 1. By way of example, the computer system 100 may include video memory, cache memory, as well as other dedicated memory, and additional signal lines and buses. Again, the present invention is generally applicable to all types of computer systems, irrespective of the particular architecture employed.

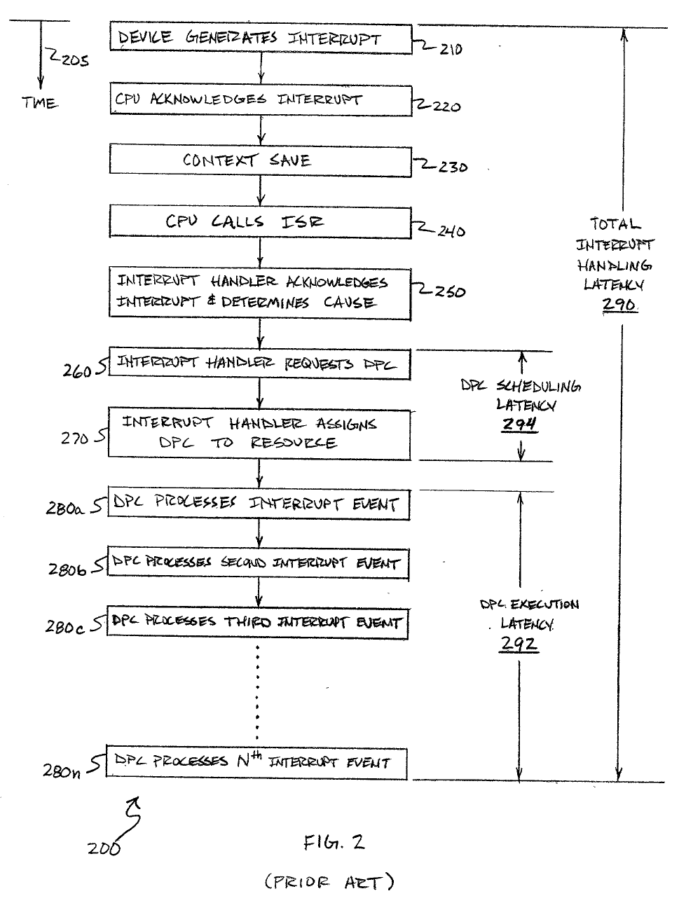

A schematic diagram of a conventional method of interrupt processing 200 is shown in FIG. 2. The interrupt handling method 200 is diagrammed along a vertical axis 205 corresponding to time.

Referring to FIG. 2, during operation of computer system 100, one of the peripheral devices 150 may generate an interrupt 210. The CPU 110 will acknowledge the interrupt 220 and then perform a context save 230, such that execution of any interrupted code may be resumed after completion of interrupt processing. The CPU 110 will call and execute the interrupt service routine (ISR) 240 of the driver 180 associated with the device 150 that generated the interrupt. The interrupt service routine includes an interrupt handler and a deferred procedure. The interrupt handler will acknowledge the interrupt and determine its cause, which is denoted at 250. The interrupt handler then requests the deferred procedure call 260 to process the interrupt event and assigns the deferred procedure call to a resource 270, such as a thread 112 of CPU 110. The deferred procedure call subsequently processes the interrupt event, as denoted at 280a.

If multiple interrupt events on device 150 caused the generation of the interrupt, or if one or more additional interrupt events occur after the interrupt event that originally caused the interrupt to be asserted, the deferred procedure call will serially process all of the interrupt events. For example, after the deferred procedure call processes the first interrupt event 280a, the deferred procedure call processes a second interrupt event 280b and processes a third interrupt event 280c. The procedure continues until the deferred procedure call has processed the final outstanding interrupt event (i.e., interrupt event N), denoted at 280n. When all (or a threshold number) of the outstanding interrupt events of device 150 have been processed, the CPU 110 will return to normal operation.

The deferred procedure call requested by the interrupt handler to process the plurality of interrupt events is executed in the CPU 110 on a single thread of execution 112. Accordingly, the interrupt events are serially processed in the CPU 110, as is shown in FIG. 2. Thus, a long period of time—i.e., the DPC execution latency 292—is required to process all interrupt events on the single deferred procedure call executing on thread 112, and this DPC execution latency 292 comprises a significant portion of the total time required to process the interrupts, or total interrupt handling latency 290. A portion of the total interrupt handling latency also comprises the DPC scheduling latency 294.

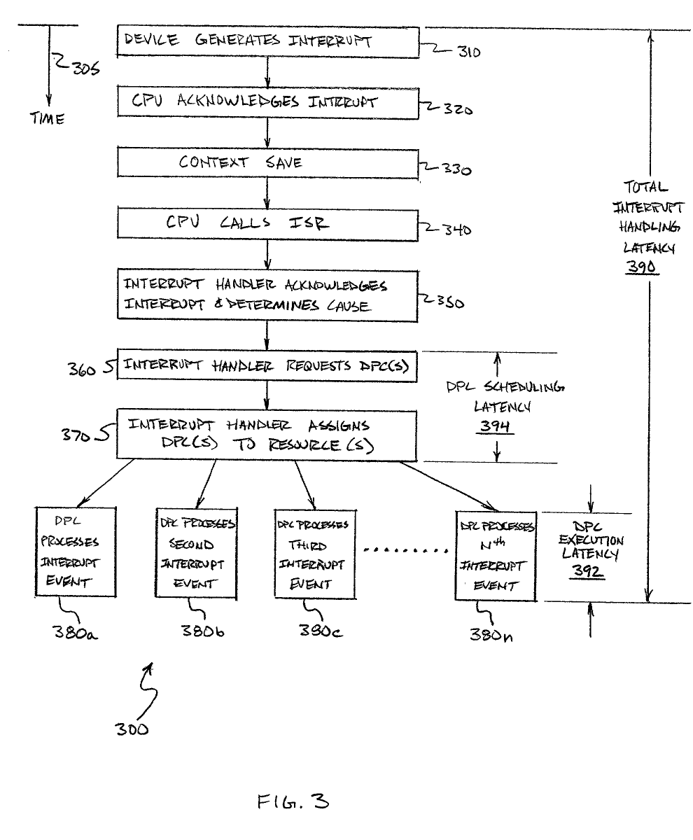

A method of interrupt processing 300 according to the present invention is illustrated in FIG. 3. The method of interrupt processing 300 provides a decreased total interrupt handling latency by significantly reducing the DPC execution latency. In FIG. 3, the interrupt processing method 300 is diagrammed along a vertical axis 305 corresponding to time.

Referring now to FIG. 3, one peripheral device 150 of computer system 100 generates an interrupt 310. The CPU 110 will acknowledge the interrupt 320 and then perform a context save 330, such that execution of any interrupted code may be resumed after completion of interrupt processing. The CPU 110 will call and execute the interrupt service routine (ISR) 340 of the driver 180 associated with the device 150 that generated the interrupt. The interrupt service routine includes an interrupt handler and two or more deferred procedure calls, each deferred procedure call corresponding to a type of interrupt event on device 150. A deferred procedure call may be configured to process more than one type or class of interrupt event. The interrupt handler will acknowledge the interrupt and determine which interrupt event(s) caused the interrupt 350. The interrupt handler subsequently requests the appropriate deferred procedure call 360 to process the interrupt event and assigns the deferred procedure call to a resource, as denoted at 370. The interrupt event is then processed by the deferred procedure, as denoted at 380a.

If multiple interrupt events on device 150 caused the generation of the interrupt, or if one or more additional interrupt events occur after the interrupt event that originally caused the interrupt to be asserted, the interrupt handler will request a deferred procedure call for each of the multiple interrupt events, as denoted at 360. By way of example, in addition to the deferred procedure call requested to process the first interrupt event, a deferred procedure call is requested to process a second interrupt event and a deferred procedure call is requested to process a third interrupt event. A deferred procedure call is requested for all outstanding interrupt events, including the final interrupt event (i.e., interrupt event N). Again, a deferred procedure call may be configured to process more than one type of interrupt event, and the number of deferred procedure calls requested by the interrupt handler may, in practice, be less than the total number of interrupt events being processed.

The interrupt handler then assigns each of the deferred procedure calls to a resource, as denoted at 370, and each deferred procedure call then processes its corresponding interrupt event or events. Continuing from the example above, a deferred procedure call processes the first interrupt event 380a, a deferred procedure call processes the second interrupt event 380b, and a deferred procedure call processes the third interrupt event 380c. All interrupt events are processed by their respective deferred procedure calls, including the final interrupt event, as denoted at 380n. However, because a separate deferred procedure call is being requested for each interrupt event, all of the interrupt events can be processed in parallel by a plurality of deferred procedure calls executing simultaneously, as shown in FIG. 3. By concurrently processing all deferred procedure calls, the DPC execution latency 392—and, hence, the total interrupt handling latency 390—is substantially reduced in comparison to conventional interrupt handling methods.

The resource to which a deferred procedure call is assigned may comprise a CPU or processor 110 capable of executing a single thread 112, a multi-threaded processor 110 capable of concurrently executing multiple threads 112, or a group of processors 110 comprising a multi-processor system, as well as any other processor or circuitry known in the art. Alternatively, the assigned resource may comprise a specific processor 110 of a multi-processor system or a specific thread of execution 112 of a multi-threaded processor 110. The operating system 160 resident on computer system 100 will then schedule execution of the deferred procedure calls on the available resource or resources.

For a CPU 110 capable of executing a single thread 112, the operating system 160 will schedule the deferred procedure calls on a time-sharing basis. By way of example, the operating system 160 may let a first deferred procedure call execute for a period of time, suspend execution of the first deferred procedure call, and then switch to a second deferred procedure call for execution. Subsequently, the operating system 160 may suspend execution of the second deferred procedure call and switch to a third deferred procedure call for execution. At some later time, the operating system 160 may suspend execution of the third deferred procedure call and switch to yet another deferred procedure call, which then executes for a period of time. When execution of a deferred procedure call is suspended, the operating system 160 may switch to another deferred procedure call or may return to any previously (but not fully) executed deferred procedure call to continue execution of that deferred procedure call. This process of switching between deferred procedure calls continues until execution of all deferred procedure calls—and the interrupt events being processed by each—is complete. The time-sharing or switching process is transparent to the deferred procedure calls, providing an “apparent” parallel execution.

For a multi-threaded processor 110, the operating system 160 may schedule each deferred procedure call to concurrently execute on separate threads. For example, if three interrupt events occur and an interrupt is generated by a peripheral device 150 and a deferred procedure call is requested for each of these interrupt events and assigned to its own thread of execution 112, the operating system 160 may schedule the threads 112 or deferred procedure calls to run simultaneously on the multi-threaded processor 110, providing a “true” parallel interrupt processing. It should be understood that, even for a multi-threaded processor, there may be more outstanding interrupt events awaiting processing than there are execution threads 112. In such a circumstance, the operating system 160 will again engage in a time-sharing scheme, as described above. By way of example, for a processor 110 capable of simultaneously executing three threads 112, if five interrupt events occur and an interrupt is generated by peripheral device 150 and a deferred procedure call for each has been requested and assigned to a resource (i.e., the multi-threaded processor 110 or a specific thread 112 thereof), the operating system 160 will share the three execution threads 112 between the five deferred procedure calls until all deferred procedure calls have been processed. Some deferred procedure calls may execute continuously from start to end on a single thread, while some deferred procedure calls will execute intermittently on an execution thread 112 or execute intermittently on two or more threads 112.

For a multi-processor system, the operating system 160 may schedule all deferred procedure calls to execute concurrently. For example, if three interrupt events occur and an interrupt is generated by a peripheral device 150 and a deferred procedure call has been requested for each of these interrupt events and assigned to a separate processor 110, the operating system 160 may schedule the deferred procedure calls to run simultaneously on the three separate processors, providing a “true” parallel interrupt processing. It should be understood that, even for a multi-processor system, there may be more outstanding interrupt events awaiting processing than there are processors 110, in which case the operating system 160 will, once again, utilize a time-sharing technique. By way of example, for a multi-processor system comprising three processors 110, if five interrupt events occur and an interrupt is generated by peripheral device 150 and a deferred procedure call for each has been requested and assigned to a resource (i.e., a specific processor 110 or a group of processors), the operating system 160 will share the three processors 110 between the five deferred procedure calls until all deferred procedure calls have been processed. Some deferred procedure calls may execute continuously from start to end on a single processor, while some deferred procedure calls will execute intermittently on a processor 110 or execute intermittently on two or more processors 110.

It will be appreciated by those of ordinary skill in the art that a computer system may include multiple processors, each of the multiple processors capable of executing multiple threads. The embodiments of a driver and method for interrupt processing described herein are also applicable to such multi-processor/multi-threaded systems. Scheduling of the deferred procedure calls on such a system may provide either “true” or “apparent” parallel processing.

Those of ordinary skill in the art will also understand that, although generally associated with peripheral devices and other hardware, interrupts may originate from other sources. For example, an interrupt may be caused by a software event, such as by execution of specific machine language code, rather than a hardware event. The embodiments of a driver and method for interrupt processing described herein are equally applicable to these software event interrupts—typically referred to as “software interrupts”—as well as interrupts originating from other sources.

Embodiments of a driver and method for interrupt processing having been described herein, those of ordinary skill in the art will appreciate the many advantages thereof. A driver according to the invention—by requesting a separate deferred procedure call for each of a plurality of interrupt events and separately processing these interrupt events using their respective deferred procedure call executing on its own execution thread (or, alternatively, its own processor)—is capable of parallel interrupt processing. Such a driver may also be used in conjunction with a processor providing only a single thread of execution to provide an “apparent” parallel interrupt processing. If necessary, execution of the deferred procedure calls may be scheduled on a resource (or resources) on a time-sharing basis. Using a series of drivers providing parallel interrupt processing according to the invention, a computer system may achieve greater system throughput and overall capacity, as compared to conventional drivers.

Utilizing embodiments of the method described herein, drivers for parallel devices would realize an even greater improvement in performance. A parallel device is one capable of executing two functions—e.g., transmit and receive—simultaneously. For this example, an interrupt event associated with the transmit function would have one deferred procedure call and an interrupt event associated with the receive function would have another, separate deferred procedure call, and these separate deferred procedure calls may, utilizing the method set forth above, be executed in parallel.

The foregoing detailed description and accompanying drawings are only illustrative and not restrictive. They have been provided primarily for a clear and comprehensive understanding of the present invention and no unnecessary limitations are to be understood therefrom. Numerous additions, deletions, and modifications to the embodiments described herein, as well as alternative arrangements, may be devised by those skilled in the art without departing from the spirit of the present invention and the scope of the appended claims.

### APPENDIX A

William E. Alford, Reg. No. 37,764; Farzad E. Amini, Reg. No. 42,261; William Thomas Babbitt, Reg. No. 39,591; Carol F. Barry, Reg. No. 41,600; Jordan Michael Becker, Reg. No. 39,602; Lisa N. Benado, Reg. No. 39,995; Bradley J. Bereznak, Reg. No. 33,474; Michael A. Bemadicou, Reg. No. 35,934; Roger W. Blakely, Jr., Reg. No. 25,831; R. Alan Burnett, Reg. No. 46,149; Gregory D. Caldwell, Reg. No. 39,926; Andrew C. Chen, Reg. No. 43,544; Thomas M. Coester, Reg. No. 39,637; Donna Jo Coningsby, Reg. No. 41,684; Florin Corie, Reg. No. 46,244; Dennis M. deGuzman, Reg. No. 41,702; Stephen M. De Klerk, Reg. No. P46,503; Michael Anthony DeSanctis, Reg. No. 39,957; Daniel M. De Vos, Reg. No. 37,813; Justin M. Dillon, Reg. No. 42,486 ; Sanjeet Dutta, Reg. No. P46,145; Matthew C. Fagan, Reg. No. 37,542; Tarek N. Fahmi, Reg. No. 41,402; George Fountain, Reg. No. 37,374; James Y. Go, Reg. No. 40,621; James A. Henry, Reg. No. 41,064; Willmore F. Holbrow III, Reg. No. P41,845; Sheryl Sue Holloway, Reg. No. 37,850, George W Hoover II, Reg. No. 32,992; Eric S. Hyman, Reg. No. 30,139; William W. Kidd, Reg. No. 31,772; Sang Hui Kim, Reg. No. 40,450; Walter T. Kim, Reg. No. 42,731; Eric T. King, Reg. No. 44,188; Erica W. Kuo, Reg. No. 42,775; George B. Leavell, Reg. No. 45,436; Kurt P. Leyendecker, Reg. No 42,799; Gordon R. Lindeen III, Reg. No. 33,192; Jan Carol Little, Reg. No. 41,181; Robert G. Litts, Reg. No. 46,876; Julio Loza, Reg. No. P47,758; Joseph Lutz, Reg. No. 43,765; Michael J. Mallie, Reg. No. 36,591; Andre L. Marais, under 37 C.F.R. § 10.9(b); Paul A. Mendonsa, Reg. No. 42,879; Clive D. Menezes, Reg. No. 45,493; Chun M. Ng, Reg. No. 36,878; Thien T. Nguyen, Reg. No. 43,835; Thinh V. Nguyen, Reg. No. 42,034; Dennis A. Nicholls, Reg. No. 42,036; Daniel E. Ovanezian, Reg. No. 41,236; Kenneth B. Paley, Reg. No. 38,989; Gregg A. Peacock, Reg. No. 45,001; Marina Portnova, Reg. No. P45,750; Michael A. Proksch, Reg. No. 43,021; William F. Ryann, Reg. 44,313; James H. Salter, Reg. No. 35,668; William W. Schaal, Reg. No. 39,018; James C. Scheller, Reg. No. 31,195; Jeffrey S. Schubert, Reg. No. 43,098; George Simion, Reg. No P47,089; Jeffrey Sam Smith, Reg. No. 39,377; Maria McCormack Sobrino, Reg. No 31,639; Stanley W. Sokoloff, Reg. No. 25,128; Judith A. Szepesi, Reg. No. 39,393; Vincent P. Tassinari Reg. No. 42,179, Edwin H. Taylor, Reg. No. 25,129; John F. Travis, Reg. No. 43,203; Joseph A. Twarowski, Reg. No. 42,191; Kerry D. Tweet, Reg. No. 45,959; Mark C. Van Ness, Reg. No. 39,865; Thomas A. Van Zandt, Reg. No. 43,219; Lester J. Vincent, Reg. No. 31,460; Glenn E. Von Tersch, Reg. No. 41,364; John Patrick Ward, Reg. No. 40,216; Mark L. Watson, Reg. No. P46,322; Thomas C. Webster, Reg. No. P46,154; and Norman Zafman, Reg. No. 26,250, my patent attorneys, and Raul Martinez, Reg. No. 46,904, my patent agents; of BLAKELY, SOKOLOFF, TAYLOR & ZAFMAN LLP, with offices located at 12400 Wilshire Boulevard, 7th Floor, Los Angeles, Calif. 90025, telephone (310) 207-3800, and Alan K. Aldous, Reg. No. 31,905; Robert D. Anderson, Reg. No. 33,826; Joseph R. Bond, Reg. No. 36,458; Richard C. Calderwood, Reg. No. 35,468; Paul W. Churilla, Reg. No. P47,495; Jeffrey S. Draeger, Reg. No. 41,000; Cynthia Thomas Faatz, Reg No. 39,973; Sean Fitzgerald, Reg. No. 32,027; John N. Greaves, Reg. No. 40,362; John F. Kacvinsky, Reg No. 40,040; Seth Z. Kalson, Reg. No. 40,670; David J. Kaplan, Reg. No. 41,105; Charles A. Mirho, Reg. No. 41,199; Leo V. Novakoski, Reg. No. 37,198; Naomi Obinata, Reg. No. 39,320; Thomas C. Reynolds, Reg. No. 32,488; Kenneth M. Seddon, Reg. No. 43,105; Mark Seeley, Reg. No. 32,299; Steven P. Skabrat, Reg. No. 36,279; Howard A Skaist, Reg. No. 36,008; Steven C. Stewart, Reg. No. 33,555; Raymond J. Werner, Reg. No. 34,752; Robert G. Winkle, Reg. No. 37,474; Steven D. Yates, Reg. No. 42,242, and Charles K. Young, Reg. No. 39,435; my patent attorneys, Thomas Raleigh Lane, Reg. No. 42,781; Calvin E. Wells; Reg. No. P43,256, Peter Lam, Reg. No. 44,855; Michael J. Nesheiwat, Reg. No. P47,819; and Gene I. Su, Reg No. 45,140; my patent agents, of INTEL CORPORATION; and James R. Thein, Reg. No. 31,710, my patent attorney; with full power of substitution and revocation, to prosecute this application and to transact all business in the Patent and Trademark Office connected herewith.

What is claimed is:

1. A method comprising:
requesting a first deferred procedure call for a first interrupt event;
requesting at least one other deferred procedure call for a second interrupt event;
assigning the first deferred procedure call and the at least one other deferred procedure call to a resource;
processing the first interrupt event with the first deferred procedure call; and
processing the second interrupt event with the at least one other deferred procedure call.

2. The method of claim 1, further comprising:
assigning the first deferred procedure call and the at least one other deferred procedure
call to a resource comprising a processor exhibiting a single thread of execution; and
executing the first deferred procedure call and the at least one other deferred procedure call on the single thread.

3. The method of claim 1, further comprising:
assigning the first deferred procedure call and the at least one other deferred procedure call to a resource comprising a processor exhibiting a plurality of threads; and
executing the first deferred procedure call on one thread of the plurality of threads while executing the at least one other deferred procedure call on another thread of the plurality of threads.

4. The method of claim 1, further comprising:
assigning the first deferred procedure call to a resource comprising a first thread of a processor;
assigning the at least one other deferred procedure call to a resource comprising a second thread of the processor; and
executing the first deferred procedure call on the first thread while executing the at least one other deferred procedure call on the second thread.

5. The method of claim 1, further comprising:
assigning the first deferred procedure call and the at least one other deferred procedure call to a resource comprising a multi-processor system; and
executing the first deferred procedure call on one processor of the multi-processor system while executing the at least one other deferred procedure call on another processor of the multi-processor system.

6. The method of claim 1, further comprising:
assigning the first deferred procedure call to a resource comprising a first processor;
assigning the at least one other deferred procedure call to a resource comprising a second processor; and
executing the first deferred procedure call on the first processor while executing the at least one other deferred procedure call on the second processor.

7. The method of claim 1, further comprising processing another interrupt event with one of the first deferred procedure call and the at least one other deferred procedure call.

8. A method comprising:
requesting a first deferred procedure call for a first interrupt event;
requesting at least one other deferred procedure call for a second interrupt event; and
processing the first interrupt event with the first deferred procedure call while processing the second interrupt event with the at least one other deferred procedure call.

9. The method of claim 8, further comprising:
executing the first deferred procedure call on a first thread of a processor; and
executing the at least one other deferred procedure call on a second thread of the processor.

10. The method of claim 8, further comprising:
executing the first deferred procedure call on a first processor; and
executing the at least one other deferred procedure call on a second processor.

11. The method of claim 8, further comprising processing another interrupt event with one of the first deferred procedure call and the at least one other deferred procedure call.

12. A driver comprising:
an interrupt handler to identify interrupt events; and
at least two deferred procedure calls, each of the at least two deferred procedure calls to process at least one of the interrupt events.

13. The driver of claim 12, the interrupt handler to assign the at least two deferred procedure calls to a resource for execution.

14. The driver of claim 12, the interrupt handler to assign one of the at least two deferred procedure calls to a first resource for execution and another of the at least two deferred procedure calls to a second resource for execution.

15. A computer system comprising:
a driver stored in a memory of the computer system, the driver including
an interrupt handler to identify interrupt events; and
at least two deferred procedure calls, each of the at least two deferred procedure calls to process at least one of the interrupt events.
and
a processor to execute the at least two deferred procedure calls.

16. The computer system of claim 15, the interrupt handler to assign the at least two deferred procedure calls to a single thread exhibited by the processor for execution.

17. The computer system of claim 15, the interrupt handler to assign a first of the at least two deferred procedure calls to one thread of the processor and another of the at least two deferred procedure calls to a second thread of the processor for execution.

18. The computer system of claim 15, the interrupt handler to assign one of the at least two deferred procedure calls to the processor and another of the at least two deferred procedure calls to a second processor for execution.

19. The computer system of claim 15, further comprising at least one peripheral device, the interrupt events associated with the at least one peripheral device.

20. An article of manufacture comprising:
a machine accessible medium, the machine accessible medium providing instructions that, when executed by a machine, cause the machine to:
request a first deferred procedure call for a first interrupt event;
request at least one other deferred procedure call for a second interrupt event;
assign the first deferred procedure call and the at least one other deferred procedure call to a resource;
process the first interrupt event with the first deferred procedure call; and
process the second interrupt event with the at least one other deferred procedure call.

21. The article of claim 20, wherein the instructions, when executed, further cause the machine to:
assign the first deferred procedure call and the at least one other deferred procedure call to a resource comprising a processor exhibiting a single thread of execution; and
execute the first deferred procedure call and the at least one other deferred procedure call on the single thread.

22. The article of claim 20, wherein the instructions, when executed, further cause the machine to:
assign the first deferred procedure call and the at least one other deferred procedure call to a resource comprising a processor exhibiting a plurality of threads; and
execute the first deferred procedure call on one thread of the plurality of threads while executing the at least one other deferred procedure call on another thread of the plurality of threads.

23. The article of claim 20, wherein the instructions, when executed, further cause the machine to:
assign the first deferred procedure call to a resource comprising a first thread of a processor;
assign the at least one other deferred procedure call to a resource comprising a second thread of the processor; and
execute the first deferred procedure call on the first thread while executing the at least one other deferred procedure call on the second thread thread.

24. The article of claim 20, wherein the instructions, when executed, further cause the machine to:
assign the first deferred procedure call and the at least one other deferred procedure call to a resource comprising a multi-processor system; and
execute the first deferred procedure call on one processor of the multi-processor system while executing the at least one other deferred procedure call on another processor of the multi-processor system.

25. The article of claim 20, wherein the instructions, when executed, further cause the machine to:
assign the first deferred procedure call to a resource comprising a first processor;
assign the at least one other deferred procedure call to a resource comprising a second processor; and
execute the first deferred procedure call on the first processor while executing the at least one other deferred procedure call on the second processor.

26. The article of claim 20, wherein the instructions, when executed, further cause the machine to process another interrupt event with one of the first deferred procedure call and the at least one other deferred procedure call.

27. An article of manufacture comprising:
a machine accessible medium, the machine accessible medium providing instructions that, when executed by a machine, cause the machine to:
request a first deferred procedure call for a first interrupt event;
request at least one other deferred procedure call for a second interrupt event; and
process the first interrupt event with the first deferred procedure call while processing the second interrupt event with the at least one other deferred procedure call.

28. The article of claim 27, wherein the instructions, when executed, further cause the machine to:
execute the first deferred procedure call on a first thread of a processor; and
execute the at least one other deferred procedure call on a second thread of the processor.

29. The article of claim 27, wherein the instructions, when executed, further cause the machine to:
execute the first deferred procedure call on a first processor; and
execute the at least one other deferred procedure call on a second processor.

30. The article of claim 27, wherein the instructions, when executed, further cause the machine to process another interrupt event with one of the first deferred procedure call and the at least one other deferred procedure call.
